(19) United States
(12) Patent Application Publication
(10) Pub. No.: US 2025/0156925 A1
(43) Pub. Date: May 15, 2025

(54) DEDUPLICATING RECOMMENDATIONS TO A USER OF AN ONLINE SYSTEM USING A COMPUTER MODEL AND CLUSTERING

(71) Applicant: Maplebear Inc., San Francisco, CA (US)

(72) Inventors: Brent Luna, Oakland, CA (US); Mridul Singhai, San Francisco, CA (US); Nathan Marks, Toronto (CA); Lukasz Czekaj, North Las Vegas, NV (US); Joseph Olivier, San Bruno, CA (US)

(21) Appl. No.: 18/509,882

(22) Filed: Nov. 15, 2023

(51) Int. Cl. G06Q 30/0601

(52) U.S. Cl. CPC G06Q 30/0631

(57) ABSTRACT

A trained computer model to identify a list of representative previously purchased items for recommendation to a user of an online system. The online system clusters, based on a similarity score for each pair of items, a set of previously purchased items into multiple clusters. The online system accesses a computer model trained to predict a likelihood of engagement by the user for each item in each cluster, and applies the computer model to predict, based on one or more features of each item, the likelihood of engagement for each item in each cluster. The online system generates, based on the likelihood of engagement, a score for each item in each cluster. The online system selects, based on the score for each item, a representative item from each cluster. The online system causes a device associated with the user to display the representative item from each cluster.

### BACKGROUND

Online systems, such as online concierge systems, typically have the “Buy It Again” feature that recommends users to repurchase items that were previously purchased. However, after users have a longer purchase history, where some of the items in the purchase history are of the same type and very similar (e.g., two different types of yogurts), the “Buy It Again” recommendations can be noisy. This leads to a technical problem of how to programmatically determine which previously purchased items to use for the recommendations to a particular user of an online concierge system.

### SUMMARY

Embodiments of the present disclosure are directed to deduplicating “Buy It Again” (i.e., previously purchased) items for recommendation to a user of an online system (e.g., online concierge system) using a trained computer model and clustering.

In accordance with one or more aspects of the disclosure, the online system clusters, based at least in part on a similarity score for each pair of items of a plurality of items previously purchased by a user of an online system, the plurality of items into a plurality of clusters so that each of the plurality of clusters includes a respective subset of the plurality of items that are more similar to each other than to any other item clustered to any of remaining clusters of the plurality of clusters. The online system accesses a computer model of the online system trained to predict a likelihood of engagement by the user for each item in each of the plurality of clusters. The online system applies the computer model to predict, based at least in part on one or more features of each item in each of the plurality of clusters, the likelihood of engagement for each item in each of the plurality of clusters. The online system generates, based at least in part on the predicted likelihood of engagement, a score for each item in each of the plurality of clusters. The online system selects, based at least in part on the score for each item in each of the plurality of clusters, one or more representative items from each of the plurality of clusters. The online system causes a device associated with the user to display a user interface with the one or more representative items from each of the plurality of clusters. The online system updates, based at least in part on feedback from the user in relation to the one or more representative items, a set of parameters of the computer model.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example system architecture of an online concierge system for automatic identification of a list of representative previously purchased items for recommendation to a user of an online concierge system, in accordance with one or more embodiments.

FIG. 4 illustrates an example user interface with a list of representative previously purchased items displayed at a user client device, in accordance with one or more embodiments.

FIG. 5 is a flowchart for a method of using a computer model to identify a list of representative previously purchased items for recommendation to a user of an online concierge system, in accordance with one or more embodiments.

### DETAILED DESCRIPTION

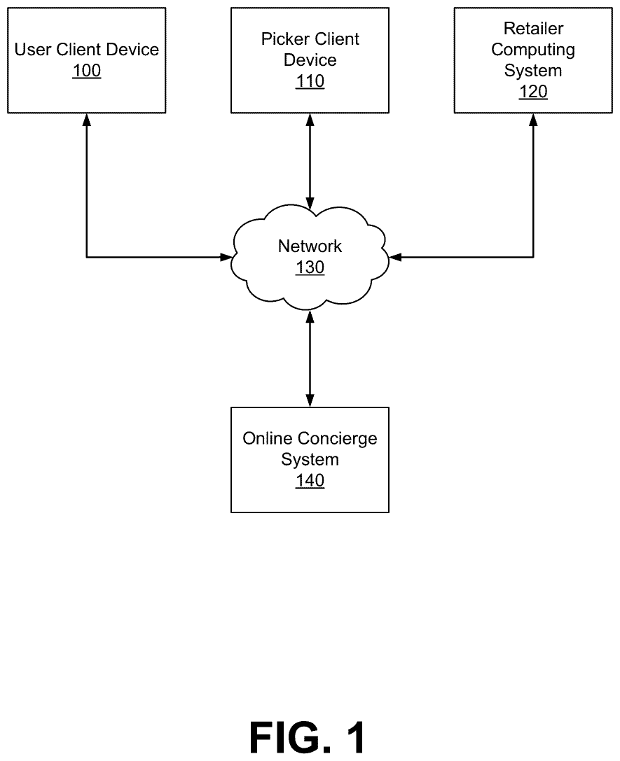

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 allows users to purchase items, and the online concierge system 140 provides “Buy It Again” suggestions to users to re-purchase items that were previously bought. However, the more a user shops at the online concierge system 140, the more cluttered their “Buy It Again” recommendations become. The user may purchase a variety of extremely similar items. For example, the user may purchase “Nonfat Vanilla Light Yogurt” one day and “Vanilla Blended Non-Fat Greek Yogurt” another day. Having both of these items in an already crowded “Buy It Again” recommendation section at a user interface of the user client device 100 may lead to smaller shopping cart sizes and a lower conversion as the user would not be efficiently reminded about previously purchased items. Hence, the goal is to filter out similar items based on the user's tendency to purchase them and recommend only highly relevant previously purchased items. For example, if the user has purchased the “Nonfat Vanilla Light Yogurt” eight times and the “Vanilla Blended Non-Fat Greek Yogurt” only once, the online concierge system 140 would filter out the “Vanilla Blended Non-Fat Greek Yogurt” and recommend only the “Nonfat Vanilla Light Yogurt” to the user via the user client device 100. Having a filtered “Buy It Again” recommendation section would lead to larger shopping carts, as there would be more space to show only the most relevant previously purchased items. This would also lead to a higher conversion and retention, as users would be more likely to identify items in the “Buy It Again” recommendation section they want to add into their carts.

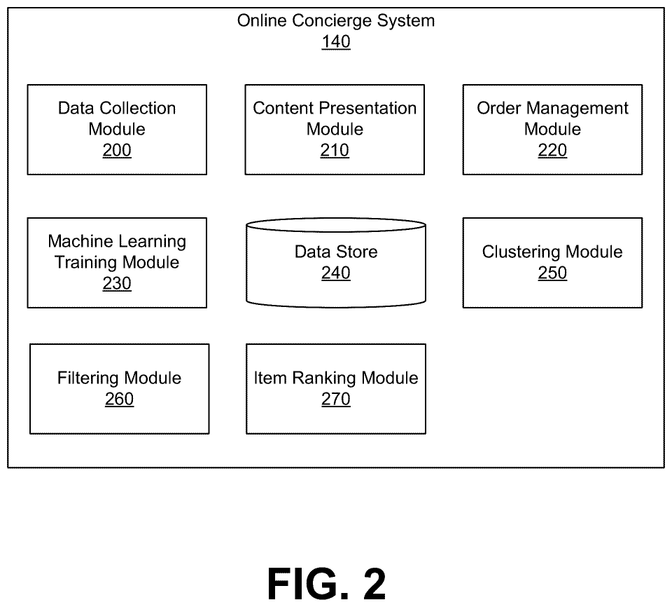

To avoid noise in the “Buy It Again” suggestions and thereby make them more useful, the online concierge system 140 clusters previously purchased items from a user's purchase history and selects one or more representative items from each cluster (e.g., based on a likelihood of conversion). The “Buy It Again” recommendations are filtered such that only the representative items are recommended to the user, thereby avoiding recommending items that are highly similar. Hence, the online concierge system 140 identifies similar items in the “Buy It Again” recommendations and filters out the less preferred items so that typically one item of a given type is recommended to the user. To achieve this, the online concierge system 140 utilizes a trained computer model (e.g., machine-learning computer model) and clustering techniques. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a clustering module 250, a filtering module 260, and an item ranking module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The clustering module 250 accesses a user's purchase history (e.g., from the data store 240) to obtain information about previously purchased items for a given user of the online concierge system 140. Upon accessing the user's purchase history and a catalog of items that were previously purchased by the user, the clustering module 250 organizes the previously purchased items into clusters, where each cluster may include a set of similar items clustered based on their embeddings, such as an item type. The clustering module 250 may apply a computer model (e.g., machine-learning model) trained to identify a similarity score for each pair of items in the catalog of previously purchased items. The computer model deployed by the clustering module 250 may run a machine-learning algorithm to identify, based on one or more features of each item in the catalog of previously purchased items, the similarity score for each pair of items in the catalog of previously purchased items. The clustering module 250 may then cluster the catalog of previously purchased items into multiple clusters, based on the identified similarity score for each pair of items in the catalog of previously purchased items. Each cluster of items may include items with the same embedding, e.g., items of the same type. A set of parameters for the computer model deployed by the clustering module 250 may be stored on one or more non-transitory computer-readable media of the clustering module 250. Alternatively, the set of parameters for the computer model deployed by the clustering module 250 may be stored on one or more non-transitory computer-readable media of the data store 240.

The filtering module 260 may filter out, based on one or more item features, certain items from the clusters formed by the clustering module 250 that do not satisfy some minimum requirements. For example, the filtering module 260 may filter out each item from the clusters formed by the clustering module 250 that is associated with a last purchase date that is further in the past than a defined threshold date. Alternatively or additionally, the filtering module 260 may filter out each item from the clusters formed by the clustering module 250 that is associated with a repurchase frequency that is less than a threshold frequency.

The item ranking module 270 ranks, according to one or more criteria, a set of items from each cluster of items formed by the clustering module 250 (and, optionally, filtered by the filtering module 260 as described above) to determine a list of representative previously purchased items for recommendation to the user via the user client device 100. The item ranking module 270 applies a computer model (e.g., machine-learning model) trained to predict a likelihood of conversion by the user for each item in each cluster of items. The computer model deployed by the item ranking module 270 may run a machine-learning algorithm to predict, based at least in part on one or more features of each item in each cluster of items, the likelihood of conversion for each item in each cluster of items. The computer model deployed by the item ranking module 270 may be a supervised machine-learning model, such as a linear regression model. A set of parameters for the computer model deployed by the item ranking module 270 may be stored on one or more non-transitory computer-readable media of the item ranking module 270. Alternatively, the set of parameters for the computer model deployed by the item ranking module 270 may be stored on one or more non-transitory computer-readable media of the data store 240.

The item ranking module 270 may provide inputs to the computer model. The inputs to the computer model may be a group of clustered items with each item in each cluster having a defined feature set. The feature set for each item may include information about how often the user purchases that particular item (i.e., repurchase frequency), a historic user's conversion rate of that item, a profit margin of that item, information about a brand associated with that item, and/or some other item feature. The computer model deployed by the item ranking module 270 may take all of these item features into account and generate a new ranking for each item within a corresponding cluster. The filtering module 260 may then select one or more items from each cluster with highest ranks for recommendation to the user.

For each cluster of items, the computer model deployed by the item ranking module 270 may generate a score for each item in that particular cluster. The item ranking module 270 may then rank, based on generated scores, all items that belong to the particular cluster. And the filtering module 260 may then select one or more items from each cluster of items based on a rank of each item in the corresponding cluster. The computer model may generate the score for each item based at least in part on the predicted likelihood of conversion by the user of that item, wherein the likelihood of conversion may be predicted based on the historic conversion rate for that item, the repurchase frequency for that item, the last purchase data of that item, etc. Alternatively or additionally, the computer model deployed by the item ranking module 270 may generate the score for each item based on some other metric, such as a profit related metric determined using information about, e.g., a profit margin for each item. In one or more embodiments, the computer model deployed by the item ranking module 270 generates the score for each item within the corresponding cluster that accounts for a user's relevancy, where the user relevancy score of “1” labels the most relevant item for the user within the corresponding cluster and the user relevancy score of “0” labels the least relevant item for the user within the corresponding cluster.

The computer model deployed by the item ranking module 270 thus outputs, for each cluster of items formed by the clustering module 250, a list of ranked items. One example output of the computer model that includes an array of ranked items for four clusters, “Raisin”, “Regular Milk”, “Vanilla Yogurt” and “Oatmilk”, where one or more items within each cluster are ranked based on the user relevancy score is:

```
[
[ { name: Raisin Bran, user_relevancy: 1, profit_margin: $0.08, date_since_last_purchase: 10
days, suggested_frequency: 8 days } ],
[
  { name: Lucerne 2% Milk, user_relevancy: 0.99, profit_margin: $0.64,
date_since_last_purchase: 4 days, suggested_frequency: 12 days },
  { name: Horizon 2% Milk, user_relevancy: 0.87, profit_margin: $1.28,
date_since_last_purchase: 224 days, suggested_frequency: 12 days }
],
[
  { name: Lucerne Vanilla Yogurt, user_relevancy: 0.99, profit_margin: $0.44,
date_since_last_purchase: 8 days, suggested_frequency: 5 days },
  { name: Chobani Vanilla Yogurt, user_relevancy: 0.87, profit margin: $0.32,
date_since_last_purchase: 123 days, suggested_frequency: 5 days },
  { name: Oikos Vanilla Yogurt, user_relevancy: 0.85, profit_margin: $0.38,
date_since_last_purchase: 123 days, suggested_frequency: 5 days },
  { name: Greek God Vanilla Yogurt, user_relevancy: 0.42, profit_margin: $0.40,
date_since_last_purchase: 8 days, suggested_frequency: 5 days },
],
[
  { name: Oatly Oatmilk, user_relevancy: 0.92, profit_margin: −($0.08),
date_since_last_purchase: 14 days, suggested_frequency: 14 days },
  { name: Planet Oat Oatmilk, user_relevancy: 0.78, profit_margin: $1.43,
date_since_last_purchase: 123 days, suggested_frequency: 14 days }
]
}
```

In one or more embodiments, the filtering module 260 obtains the array of clustered items from the item ranking module 270 and filters out items that are less relevant to the user within each cluster, i.e., the filtering module 260 may select one item from each cluster for recommendation to the user with the highest user relevancy score within that cluster. In such cases, the example representative (or filtered) “Buy It Again” list of items that would be recommended to the user is: “[Raisin Bran, Lucerne 2% Milk, Lucerne Vanilla Yogurt, Oatly Oatmilk]”. Thus, the more likely a user is to purchase an item, the more likely that item will show up in the representative “Buy It Again” list of items. In one or more other embodiments, the filtering module 260 obtains the array of clustered items from the item ranking module 270 and filters out items based on their profit margins, i.e., the filtering module 260 selects one item from each cluster for recommendation to the user with the highest profit margin within that cluster. In such cases, the example representative (or filtered) “Buy It Again” list of items that would be recommended to the user is: “[Raisin Bran, Horizon 2% Milk, Lucerne Vanilla Yogurt, Planet Oat Oatmilk]”.

The machine-learning training module 230 may train the computer model deployed by the item ranking module 270 using a large dataset of conversion rates of particular items mixed with a dataset of user specific conversion rates. The training of the computer model would then allow the computer model to determine how relevant a particular item is to a certain user, which corresponds to the user relevancy score denoted above as the “user_relevancy”. The computer model may then cross reference the user relevancy score with other markers, such as the “profit_margin” to determine the ultimate ranking for each item within a corresponding cluster of items.

The machine-learning training module 230 may continuously update the set of parameters of the computer model deployed by the item ranking module 270 as the item ranking module 270 (or some other module of the online concierge system 140) gathers new data about how the filtering of “But It Again” items is working to increase retention and shopping cart sizes of users of the online concierge system 140. The data used by the machine-learning training module 230 for updating the set of parameters of the computer model may be also gathered based on users' feedback when two or more “But It Again” items are selected per cluster for recommendation to users. Alternatively or additionally, the data used by the machine-learning training module 230 for updating the set of parameters of the computer model may be gathered based on users' feedback when certain “But It Again” items are recommended to users even if those items do not have the highest relevancy score within corresponding clusters, if they mesh well with other items (e.g., with either other recommended “But It Again” items or items in the current shopping cart). For example, if a user selects a certain number of soda products of a first brand for inclusion in a current shopping cart, the filtering module 260 may be configured to select a second ranked soda product of the first brand over a top ranked soda product of a second brand for “But It Again” recommendation to the user.

The content presentation module 210 may obtain the representative list of “Buy It Again” items from the filtering module 260 and cause the user client device 100 to display a “Buy It Again” user interface with the representative list of “Buy It Again” items. The content presentation module 210 (or some other module of the online concierge system 140) may determine, based on information about a repurchase frequency for each item in the representative list of “Buy It Again” items, a timestamp for displaying the representative list of “Buy It Again” items at the “Buy It Again” user interface of the user client device 100. The content presentation module 210 may then cause the user client device 100 to display the “Buy It Again” user interface with the representative list of “Buy It Again” items at the determined timestamp.

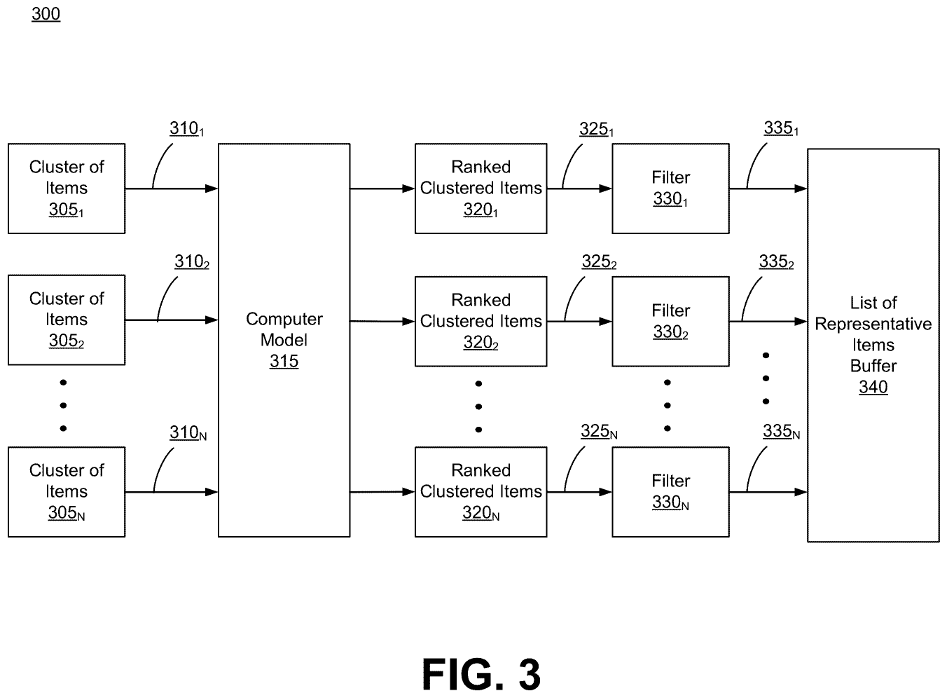

FIG. 3 illustrates an example system architecture 300 at the online concierge system 140 for automatic identification of a list of representative previously purchased items for recommendation to a user of the online concierge system 140, in accordance with one or more embodiments. The system architecture 300 has the access to multiple clusters of items 305₁, 305₂, . . . , 305_{N} as generated by, e.g., the clustering module 250 based on a user's purchase history (e.g., as available at the data store 240). Each cluster of items 305₁, 305₂, . . . , 305_{N} along with a respective feature set 310₁, 310₂, . . . , 310_{N} that includes features of items in each cluster of items 305₁, 305₂, . . . , 305_{N} may be provided as inputs to a computer model 315. In one or more embodiments, certain items from the cluster of items 305₁, 305₂, . . . , 305_{N} that do not meet one or more minimum requirements (e.g., date since last purchase, repurchase frequency, etc.) are filtered out (e.g., by the filtering module 260) before being provided to the computer model 315.

The computer model 315 may be an embodiment of the computer model deployed by the item ranking module 270. The computer model 315 may take the clusters of items 305₁, 305₂, . . . , 305_{N} along with the feature sets 310₁, 310₂, . . . , 310_{N} to output lists of ranked clustered items 320₁, 320₂, . . . , 320_{N}. Each list of ranked clustered items 320₁, 320₂, . . . , 320_{N} may represent a list of ranked items from a corresponding cluster of items 305₁, 305₂, . . . , 305_{N}. Items in each list of ranked clustered items 320₁, 320₂, . . . , 320_{N} may be ranked based on one or more metrices, such as a user preference score, profit margin, date since last purchase, frequency of recommendation, some other metric, or some combination thereof.

The lists of ranked clustered items 320₁, 320₂, . . . , 320_{N} along with sets of scores 325₁, 325₂, . . . , 325_{N} generated for each item in each list of ranked clustered items 320₁, 320₂, . . . , 320_{N} may be provided to a set of filters 330₁, 330₂, . . . , 330_{N}. The set of filters 330₁, 330₂, . . . , 330_{N} may be part of the filtering module 260. Each filter 330₁, 330₂, . . . , 330_{N} may select a respective set of one or more representative items 335₁, 335₂, . . . , 335_{N} from each list of ranked clustered items 320₁, 320₂, . . . 320_{N} based on the corresponding set of scores 325₁, 325₂, . . . , 325_{N} for recommendation to the user. Hence, the filter 330ᵢ (i=1, 2, . . . , N) may select a set of one or more representative items 335ᵢ from the list of ranked clustered items 320ᵢ based on the set of scores 325ᵢ and filter out all other items in the list of ranked clustered items 320ᵢ. The representative items 335₁, 335₂, . . . , 335_{N} may be then stored at a list of representative items buffer 340 (e.g., as part of the content presentation module 210 or some other module of the online concierge system 140). The representative items 335₁, 335₂, . . . , 335_{N} stored in the list of representative items buffer 340 may be recommended to the user at an appropriate time (e.g., at the checkout of a particular order).

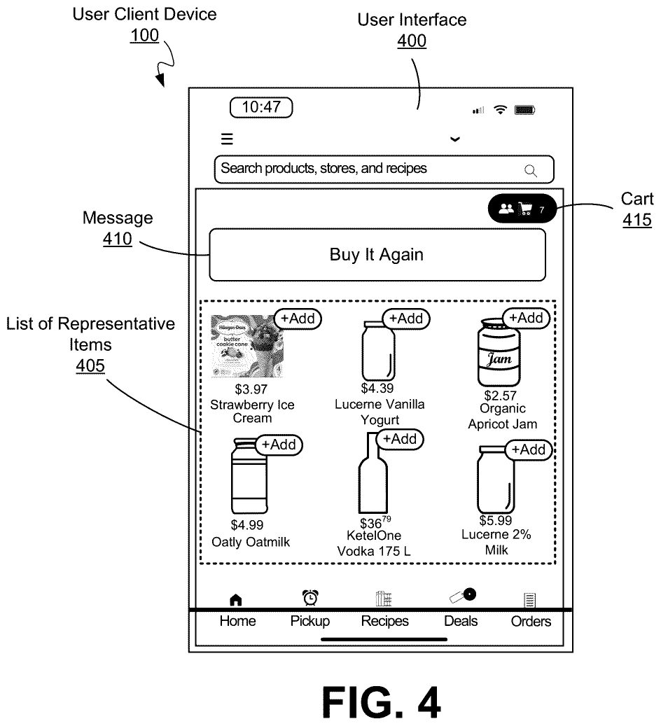

FIG. 4 illustrates an example user interface 400 with a list of representative previously purchased items 405 displayed at the user client device 100, in accordance with one or more embodiments. The user interface 400 is the “But It Again” user interface that may be displayed at the checkout or some other stage of an order process. The content presentation module 210 may cause the user client device 100 to display the user interface 400 with the list of representative “But It Again” items 405 as determined by the computer model deployed by the item ranking module 270 and the filtering module 260. The list of representative “But It Again” items 405 may be also accompanied with the “But It Again” message 410 informing the user that the list of representative items 405 are in fact “But It Again Items”. The user may then select any individual item from the list of representative items 405 for inclusion into a cart 415. In one or more embodiments, the content presentation module 210 causes the user client device 100 to display the user interface 400 with the list of representative “But It Again” items 405 for each user's order. Alternatively, the content presentation module 210 may cause the user client device 100 to display the user interface 400 with the list of representative “But It Again” items 405 only during a particular user's order as determined based on a repurchase rate by the user for each item in the list of representative “But It Again” items 405.

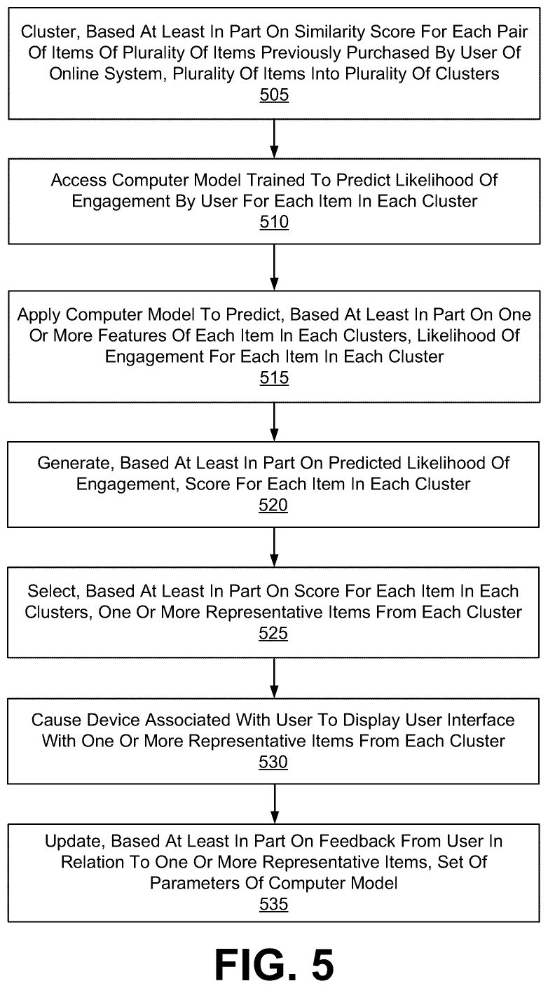

FIG. 5 is a flowchart for a method of using a computer model to identify a list of representative previously purchased items for recommendation to a user of an online concierge system, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., the online concierge system 140). Additionally, each of these steps may be performed automatically by the online concierge system without human intervention.

The online concierge system 140 clusters 505 (e.g., via the clustering module 250), based at least in part on a similarity score for each pair of items of a plurality of items previously purchased by a user of the online concierge system 140, the plurality of items into a plurality of clusters so that each of the plurality of clusters includes a respective subset of the plurality of items that are more similar to each other than to any other item clustered to any of remaining clusters of the plurality of clusters. The online concierge system 140 may access (e.g., via the clustering module 250), from a database of the online concierge system 140 (e.g., as available in the data store 240), information about the plurality of items previously purchased by the user. The online concierge system 140 may access a second computer model of the online concierge system 140 (e.g., via the clustering module 250) trained to identify the similarity score for each pair of items of the plurality of items. The online concierge system 140 may apply the second computer model (e.g., via the clustering module 250) to identify, based on one or more features of each item of the plurality of items obtained from the accessed information, the similarity score for each pair of items of the plurality of items. The online concierge system 140 may generate (e.g., by the clustering module 250), based on the accessed information, an embedding for each item of the plurality of items (e.g., an item type). The online concierge system 140 may apply the second computer model (e.g., via the clustering module 250) to identify the similarity score for each pair of items of the plurality of items by at least comparing a pair of corresponding embeddings for each pair of items of the plurality of items.

The online concierge system 140 accesses 510 a computer model of the online concierge system 140 (e.g., via the item ranking module 270) trained to predict a likelihood of engagement for each item in each of the plurality of clusters. Engagement for an item may be e.g., viewing of an item by the user, conversion of an item by the user, some other type of user's engagement, or some combination thereof. The likelihood of engagement may correspond to a likelihood of viewing an item by the user. Alternatively, the likelihood of engagement may correspond to a likelihood of conversion of an item by the user. Prior to accessing the computer model, the online concierge system 140 may filter out (e.g., via the filtering module 260) one or more items from the plurality of clusters. Each of the one or more filtered items may be associated with at least one of a last purchase date or a repurchase frequency that do not satisfy one or more minimum threshold requirements.

The online concierge system 140 applies 515 the computer model (e.g., via the item ranking module 270) to predict, based at least in part on one or more features of each item in each of the plurality of clusters, the likelihood of engagement for each item in each of the plurality of clusters. The online concierge system 140 may apply the computer model (e.g., via the item ranking module 270) to predict, based at least in part on information about at least one of a repurchase frequency or a last purchase date for each item in each of the plurality of clusters, the likelihood of engagement for each item in each of the plurality of clusters.

The online concierge system 140 generates 520 (e.g., via the computer model deployed by the item ranking module 270), based at least in part on the predicted likelihood of engagement, a score for each item in each of the plurality of clusters. The online concierge system 140 may apply the computer model (e.g., via the item ranking module 270) to generate, further based on one or more features of each item in each of the plurality of clusters, at least a component of the score that accounts for a level of relevancy to the user of each item in each of the plurality of clusters. The online concierge system 140 selects 525 (e.g., via the filtering module 260), based at least in part on the score for each item in each of the plurality of clusters, one or more representative items from each of the plurality of clusters. The online concierge system 140 may select (e.g., via the filtering module 260), further based on information about a profit margin for each item in each of the plurality of clusters, the one or more representative items from each of the plurality of clusters. The online concierge system 140 may rank (e.g., via the item ranking module 270), based at least in part on the generated score for each item, each item in each of the plurality of clusters. The online concierge system 140 may select (e.g., via the filtering module 260) a highest ranked item in each of the plurality of clusters as a representative item for displaying at the user interface.

The online concierge system 140 may access (e.g., via the item ranking module 270), from a database of the online concierge system 140 (e.g., as available at the data store 240) information about engagement rates (e.g., conversion rates) for a set of items. The online concierge system 140 may apply the computer model (e.g., via the item ranking module 270) to generate, based at least in part on the information about the engagement rates for the set of items, a training dataset with information about a likelihood of engagement (e.g., likelihood of conversion) by the user for each item in the set of items. The online concierge system 140 may train (e.g., via the machine-learning training module 230), based at least in part on the training dataset, the computer model to identify a level of relevancy to the user for each item in the set of items.

The online concierge system 140 causes 530 (e.g., via the content presentation module 210) a device associated with the user (e.g., the user client device 100) to display a user interface with the one or more representative items from each of the plurality of clusters. The online concierge system 140 may identify (e.g., via the content presentation module 210), based on information about a repurchase frequency for each of the one or more representative items, a timestamp for displaying the one or more representative items. The online concierge system 140 may cause (e.g., via the content presentation module 210) the device associated with the user to display the user interface with the one or more representative items from each of the plurality of clusters at the identified timestamp.

The online concierge system 140 updates 535 (e.g., via the via the machine-learning training module 230), based at least in part on feedback from the user in relation to the one or more representative items, a set of parameters of the computer model. The online concierge system 140 may collect (e.g., from the data store 240 via the machine-learning training module 230) information about engagement by the user for each of the one or more representative items. The collected information about engagement may include information about viewing each of the one or more representative items by the user and/or information about conversion of each of the one or more representative items by the user. The online concierge system 140 may update (e.g., via the machine-learning training module 230), based at least in part on the collected information, the set of parameters of the computer model.

Embodiments of the present disclosure are directed to the online concierge system 140 that employs a computer model trained to automatically identify a list of representative “Buy It Again” (i.e., previously purchased) items for recommendation to a user of the online concierge system 140. The online concierge system 140 utilizes the trained computer model and clustering to effectively deduplicate “Buy It Again” items for re-purchasing recommendation to the user. The online concierge system 140 applies the clustering to deduplicate similar previously purchased items and the trained computer model to select the most appropriate previously purchased for recommendation to the user. In this manner, the online concierge system 140 categorizes previously purchased items to reduce re-purchase recommendation overload to users and showing multiple items that are almost the same.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
clustering, based at least in part on a similarity score for each pair of items of a plurality of items previously purchased by a user of an online system, the plurality of items into a plurality of clusters so that each of the plurality of clusters includes a respective subset of the plurality of items that are more similar to each other than to any other item clustered to any of remaining clusters of the plurality of clusters;
accessing a computer model of the online system trained to predict a likelihood of engagement by the user for each item in each of the plurality of clusters;
applying the computer model to predict, based at least in part on one or more features of each item in each of the plurality of clusters, the likelihood of engagement for each item in each of the plurality of clusters;
generating, based at least in part on the predicted likelihood of engagement, a score for each item in each of the plurality of clusters;
selecting, based at least in part on the score for each item in each of the plurality of clusters, one or more representative items from each of the plurality of clusters;
causing a device associated with the user to display a user interface with the one or more representative items from each of the plurality of clusters; and
updating, based at least in part on feedback from the user in relation to the one or more representative items, a set of parameters of the computer model.

2. The method of claim 1, wherein clustering the plurality of items comprises:
accessing, from a database of the online system, information about the plurality of items previously purchased by the user;
accessing a second computer model of the online system trained to identify the similarity score for each pair of items of the plurality of items; and
applying the second computer model to identify, based on the one or more features of each item of the plurality of items obtained from the accessed information, the similarity score for each pair of items of the plurality of items.

3. The method of claim 2, wherein clustering the plurality of items further comprises:
generating, based on the accessed information, an embedding for each item of the plurality of items; and
applying the second computer model to identify the similarity score for each pair of items of the plurality of items by at least comparing a pair of corresponding embeddings for each pair of items of the plurality of items.

4. The method of claim 1, further comprising:
prior to accessing the computer model, filtering out one or more items from the plurality of clusters, each of the one or more items associated with at least one of a last purchase date or a repurchase frequency that do not satisfy one or more minimum threshold requirements.

5. The method of claim 1, wherein applying the computer model comprises:
applying the computer model to predict, based at least in part on information about at least one of a repurchase frequency or a last purchase date for each item in each of the plurality of clusters, the likelihood of engagement for each item in each of the plurality of clusters.

6. The method of claim 1, wherein generating the score for each item in each of the plurality of clusters comprises:
applying the computer model to generate, further based on the one or more features of each item in each of the plurality of clusters, at least a component of the score that accounts for a level of relevancy to the user of each item in each of the plurality of clusters.

7. The method of claim 1, wherein selecting the one or more representative items comprises:
selecting, further based on information about a profit margin for each item in each of the plurality of clusters, the one or more representative items from each of the plurality of clusters.

8. The method of claim 1, wherein selecting the one or more representative items comprises:
ranking, based at least in part on the generated score for each item, each item in each of the plurality of clusters; and
selecting a highest ranked item in each of the plurality of clusters as a representative item for displaying at the user interface.

9. The method of claim 1, further comprising:
accessing, from a database of the online system, information about engagement rates for a set of items;
applying the computer model to generate, based at least in part on the information about the engagement rates for the set of items, a training dataset with information about a likelihood of engagement by the user for each item in the set of items; and
training, based at least in part on the training dataset, the computer model to identify a level of relevancy to the user for each item in the set of items.

10. The method of claim 1, wherein updating the set of parameters of the computer model comprises:
collecting information about engagement by the user for each of the one or more representative items; and
updating, based at least in part on the collected information, the set of parameters of the computer model.

11. The method of claim 1, wherein displaying the user interface comprises:
identifying, based on information about a repurchase frequency for each of the one or more representative items, a timestamp for displaying the one or more representative items; and
causing the device associated with the user to display the user interface with the one or more representative items from each of the plurality of clusters at the identified timestamp.

12. A computer program product comprising a non-transitory computer readable storage medium having instructions encoded thereon that, when executed by a processor, cause the processor to perform steps comprising:
clustering, based at least in part on a similarity score for each pair of items of a plurality of items previously purchased by a user of an online system, the plurality of items into a plurality of clusters so that each of the plurality of clusters includes a respective subset of the plurality of items that are more similar to each other than to any other item clustered to any of remaining clusters of the plurality of clusters;
accessing a computer model of the online system trained to predict a likelihood of engagement by the user for each item in each of the plurality of clusters;
applying the computer model to predict, based at least in part on one or more features of each item in each of the plurality of clusters, the likelihood of engagement for each item in each of the plurality of clusters;
generating, based at least in part on the predicted likelihood of engagement, a score for each item in each of the plurality of clusters;
selecting, based at least in part on the score for each item in each of the plurality of clusters, one or more representative items from each of the plurality of clusters;
causing a device associated with the user to display a user interface with the one or more representative items from each of the plurality of clusters; and
updating, based at least in part on feedback from the user in relation to the one or more representative items, a set of parameters of the computer model.

13. The computer program product of claim 12, wherein the instructions further cause the processor to perform steps comprising:
accessing, from a database of the online system, information about the plurality of items previously purchased by the user;
accessing a second computer model of the online system trained to identify the similarity score for each pair of items of the plurality of items; and
applying the second computer model to identify, based on the one or more features of each item of the plurality of items obtained from the accessed information, the similarity score for each pair of items of the plurality of items.

14. The computer program product of claim 13, wherein the instructions further cause the processor to perform steps comprising:
generating, based on the accessed information, an embedding for each item of the plurality of items; and
applying the second computer model to identify the similarity score for each pair of items of the plurality of items by at least comparing a pair of corresponding embeddings for each pair of items of the plurality of items.

15. The computer program product of claim 12, wherein the instructions further cause the processor to perform steps comprising:
applying the computer model to predict, based at least in part on information about at least one of a repurchase frequency or a last purchase date for each item in each of the plurality of clusters, the likelihood of engagement for each item in each of the plurality of clusters.

16. The computer program product of claim 12, wherein the instructions further cause the processor to perform steps comprising:
applying the computer model to generate, further based on the one or more features of each item in each of the plurality of clusters, at least a component of the score that accounts for a level of relevancy to the user of each item in each of the plurality of clusters.

17. The computer program product of claim 12, wherein the instructions further cause the processor to perform steps comprising:
ranking, based at least in part on the generated score for each item, each item in each of the plurality of clusters; and
selecting a highest ranked item in each of the plurality of clusters as a representative item for displaying at the user interface.

18. The computer program product of claim 12, wherein the instructions further cause the processor to perform steps comprising:
accessing, from a database of the online system, information about engagement rates for a set of items;
applying the computer model to generate, based at least in part on the information about the engagement rates for the set of items, a training dataset with information about a likelihood of engagement by the user for each item in the set of items; and
training, based at least in part on the training dataset, the computer model to identify a level of relevancy to the user for each item in the set of items.

19. The computer program product of claim 12, wherein the instructions further cause the processor to perform steps comprising:
collecting information about engagement by the user for each of the one or more representative items; and
updating, based at least in part on the collected information, the set of parameters of the computer model.

20. A computer system comprising:
a processor; and
a non-transitory computer-readable storage medium having instructions that, when executed by the processor, cause the computer system to perform steps comprising:
clustering, based at least in part on a similarity score for each pair of items of a plurality of items previously purchased by a user of an online system, the plurality of items into a plurality of clusters so that each of the plurality of clusters includes a respective subset of the plurality of items that are more similar to each other than to any other item clustered to any of remaining clusters of the plurality of clusters;
accessing a computer model of the online system trained to predict a likelihood of engagement by the user for each item in each of the plurality of clusters;
applying the computer model to predict, based at least in part on one or more features of each item in each of the plurality of clusters, the likelihood of engagement for each item in each of the plurality of clusters;
generating, based at least in part on the predicted likelihood of engagement, a score for each item in each of the plurality of clusters;
selecting, based at least in part on the score for each item in each of the plurality of clusters, one or more representative items from each of the plurality of clusters;
causing a device associated with the user to display a user interface with the one or more representative items from each of the plurality of clusters; and
updating, based at least in part on feedback from the user in relation to the one or more representative items, a set of parameters of the computer model.
